(19) United States
(12) Patent Application Publication
(10) Pub. No.: US 2012/0195321 A1
(43) Pub. Date: Aug. 2, 2012

(54) Method and Apparatus for Low-Latency Interconnection Networks Using Hierarchical Rings

(75) Inventors: Rohit Sunkam Ramanujam, Santa Clara, CA (US); Sailesh Kumar, San Jose, CA (US); William Lynch, Los Altos, CA (US)

(73) Assignee: FUTUREWEI TECHNOLOGIES, INC., Plano, TX (US)

(21) Appl. No.: 13/341,949

(22) Filed: Dec. 31, 2011

Related U.S. Application Data
(60) Provisional application No. 61/438,869, filed on Feb. 2, 2011.

(51) Int. Cl. H04L 12/56

(52) U.S. Cl. 370/405; 370/400

(57) ABSTRACT

An apparatus comprising a chip comprising a global ring network comprising a plurality of global routers configured in a unidirectional ring network, and a plurality of local ring networks directly connected to the global ring network. A method comprising transmitting a first flit from a first router to a second router, wherein a first ring network comprises the first and second routers, and transmitting a second flit from the first router to a third router, wherein a second ring network comprises the first and third routers, wherein the first and second ring networks are in a hierarchical relationship with each other, and wherein a chip comprises the first and second ring networks.

### CROSS-REFERENCE TO RELATED APPLICATIONS

The present application claims priority to U.S. Provisional Patent Application 61/438,869, filed Feb. 2, 2011 by Rohit Sunkam Ramanujam, et al., and entitled “Method and Apparatus for Low-Latency Interconnection Networks Using Hierarchical Rings,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

As transistor and other component sizes become smaller and manufacturing techniques continue to improve, more functionality is being placed on single integrated circuits, or chips. The term system on a chip (SoC) generally refers to integrating all the functionality of a computer or other complex electronic system onto a single chip. A SoC may comprise one or more memories, processors, or input/output ports, all integrated into a single chip. One way of allowing various components of a SoC to communicate is to use an on-chip network, sometimes referred to as a network-on-chip. An on-chip network is intended to replace conventional ways of communicating between electronic components in a complex system, such as conventional bus and crossbar interconnections.

Various topologies have been considered for on-chip networks, and ring topologies are sometimes used because of the relative simplicity of the routers that may be employed. For example, in a unidirectional ring network each router comprises two ports, one input port for receiving data from a first adjacent router and one output port for transmitting data to a second adjacent router. These routers occupy less area, consume less power, and can be clocked at higher frequencies compared to higher-radix on-chip routers, such as routers in mesh networks. For example, the area and power consumption of a router may scale quadratically with the number of ports, so higher-radix routers may use substantially more power and occupy substantially more area than the relatively simple routers used in unidirectional ring networks. However, ring networks may not scale well as the number of routers increases. This is because the average and worst-case packet bandwidth increase linearly with the number of routers while the bisection bandwidth remains a constant, reducing the throughput of each router. Network latency may be critical for a number of SoC applications that require ultra low latency communication and operate under tight power budgets.

### SUMMARY

Disclosed herein is an apparatus comprising a chip comprising a global ring network comprising a plurality of global routers configured in a unidirectional ring network, and a plurality of local ring networks directly connected to the global ring network.

Also disclosed herein is a method comprising transmitting a first flit from a first router to a second router, wherein a first ring network comprises the first and second routers, and transmitting a second flit from the first router to a third router, wherein a second ring network comprises the first and third routers, wherein a chip comprises the first and second ring networks.

Also disclosed herein is an apparatus comprising a chip comprising a global ring network comprising a plurality of global routers configured in a unidirectional ring network, an intermediate ring network comprising a plurality of intermediate routers configured in a unidirectional ring network, wherein the intermediate ring network is directly connected to the global ring network, and a plurality of local ring networks directly connected to the intermediate ring network.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a system on a chip.

FIG. 2 is a schematic diagram of an embodiment of a ring network.

FIG. 3 is a schematic diagram of an embodiment of a hierarchical ring network.

FIG. 4 is a schematic diagram of another embodiment of a hierarchical ring network.

FIG. 5 is a flowchart of an embodiment of flit routing method for a local router.

FIG. 6 is a flowchart of an embodiment of flit routing method for an intermediate router.

FIG. 7 is a flowchart of an embodiment of flit routing method for a global router.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are topologies that utilize certain advantages of ring networks, including the use of simple two-port routers, while at the same time achieving lower latency than ring networks. The topologies may be referred to as hierarchical ring networks, and may be described as comprising a plurality of local ring networks interconnected via a global ring network. A global ring may comprise global routers, and a local ring may comprise local routers. Hierarchical ring networks reduce the average and worst-case packet latency compared to conventional ring networks, while still using simple two-port routers to connect adjacent stations, thereby reducing design time and routing latency while improving system performance. Various embodiments of hierarchical ring networks are described in the following.

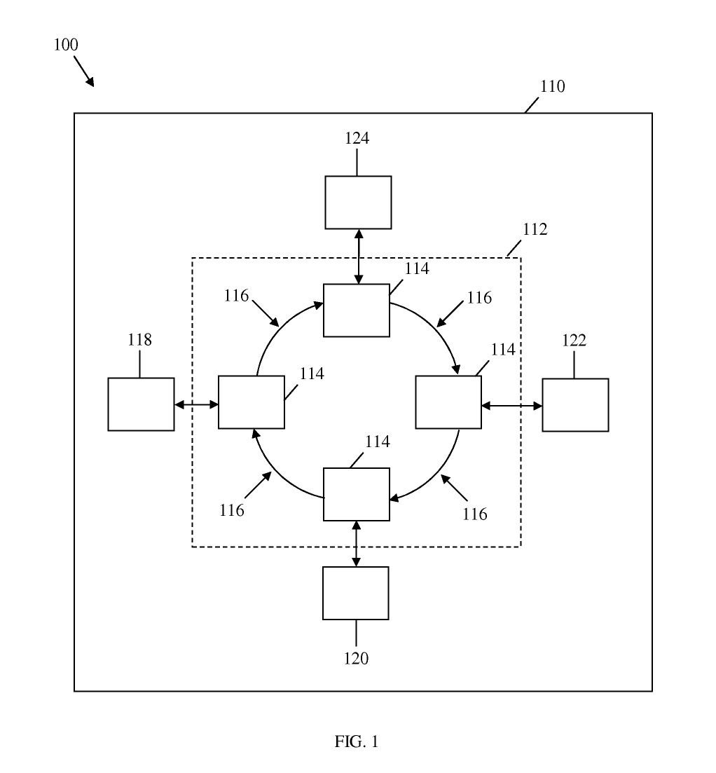

An on-chip network may be configured to provide communication capability between various components that reside in a single chip. FIG. 1 is a schematic diagram of an embodiment of a system on a chip (SoC) 100 with an on-chip network 112. Specifically, the SoC 100 comprises an on-chip network 112 comprising a plurality of routers 114, also referred to as nodes. The on-chip network 112 may be configured to provide communications capability between components 118, 120, 122, and 124 via the routers 114, where the on-chip network 112 and components 118, 120, 122, and 124 are located on a single chip 110. While four components 118, 120, 122, and 124 are illustrated in FIG. 1, it will be appreciated that an on-chip network 112 may connect any number and/or type of components 118, 120, 122, and 124.

The routers 114 may be any devices that promote routing of flits within the on-chip network 112. At least some of the routers 114 may break an incoming packet (e.g. an Internet Protocol (IP) packet or Ethernet frame) into units of information known as flow control digits, or flits, if such is not done by the components 118, 120, 122, and 124. Further, at least some of the routers 114 may reassemble the flits into an outgoing packet if such, is not done by the components 118, 120, 122, and 124. In addition, the routers 114 may perform flit routing in that they receive flits and determine which of a plurality of virtual channels on which to transmit the flits. In a similar manner, the routers 114 may perform packet routing in that they receive flits and determine which of a plurality of virtual channels on which to transmit the flits. As part of the routing, the routers 114 may arbitrate two flits or flits competing for a common resource (e.g. a virtual channel in a link 116). To perform these various functions, each router 114 may include a processor that is in communication with a memory, such as a read only memory (ROM), a random access memory (RAM), or any other type of memory. Each processor may be a general-purpose processor or may be an application-specific processor. Alternatively, at least some of the routers 114 may be implemented with no local memory, but have access to an external memory that may be located on another part of the SoC 100 and perhaps shared by other routers 114. Finally, at least some of the routers 114 may be implemented with no local memory and no memory access.

As discussed above, flits may be formed by segmenting packets, e.g., Ethernet packets or IP packets, that enter an on-chip network. A flit that enters an on-chip network may also be referred to as being injected into an on-chip network. Referring to FIG. 1 as an exemplary example, a component, such as component 122, may transmit a packet to corresponding router 114. Router 114 may be configured to receive the packet and segment the packet into smaller units of information. Alternatively, a component, such as 122, may segment a packet into smaller units. Each unit of information may be placed into a flit. There may be different types of flits, such as head flits, body flits, and tail flits. A packet that is segmented into smaller units may be distributed over a head flit, one or more body flits, and a tail flit, and these flits may maintain a specified order (e.g. head first, then body, then tail) as they are routed and/or processed on the chip 110. A head flit may be used to acquire resources in an on-chip network for the series of flits corresponding to a packet, and a tail flit may be used to release resources. A head flit may also comprise the packet's header (e.g. the packet's destination address, source address, etc.), and may contain some of the packet payload, whereas the body and tail flits generally do not contain any of the packet's header. In cases where the packet's header is particularly long, the packet's header may be included in the head flit and some of the body flits, but not the remaining body flits or the tail flit. Any scheme for assigning information to flits is within the scope of this application. Further, on-chip networks that transmit and receive packets, in addition to or instead of flits, are also within the scope of this application. For convenience, the remainder of the application addresses flits, but the application is also applicable to packets or any other unit of information utilized by a network.

The links 116 may be any devices that carry flits between routers 114 and/or components 118, 120, 122, and 124. The links 116 are typically electrical links, but may be optical or wireless links. At least some of the links 116 may be divided into a plurality of virtual channels, for example, by segmenting available link 116 resources (e.g. time and/or frequency) into a plurality of slots (e.g. time slots and/or frequency slots) that carry the flits. Although in general the links in an on-chip network may be bidirectional, the methods and systems presented herein may be applicable to ring networks with unidirectional links.

The components 118, 120, 122, and 124 may be any type of devices that process the flits. Generally, the components 118, 120, 122, and 124 may be devices that perform some function that is more specialized than the functions performed by the routers. For example, the components 118, 120, 122, and 124 may include memories, processors, input/output (I/O) devices such as ingress or egress ports, or any other electronic components. While the routers 114 may comprise processors and/or memories, the capacity and/or throughput of the processors and/or memories in the components 118, 120, 122, and 124 typically greatly exceed those of the routers 114 such that it would be not be possible or practical for the routers 114 to perform the functions performed by the components 118, 120, 122, and 124. In cases where one of the components 118, 120, 122, and 124 is an ingress port, it may remove protocol layers from an incoming packet (e.g. an IP packet or Ethernet frame) and/or break the incoming packet into flits, if such is not done by the routers 114. In cases where one of the components 118, 120, 122, and 124 is an egress port, it may reassemble the flits into an outgoing packet (e.g. an IP packet or Ethernet frame), and/or add protocol layers to the outgoing packet, if such is not done by the routers 114.

The routers 114 and links 116 may be arranged in a ring topology, which may also be referred to as a ring network, as illustrated in FIG. 1. A ring network may refer to a network topology in which each router connects to exactly two other routers. A ring network may be generally circular, or ring, shaped. Although FIG. 1 shows four routers 114, an on-chip network 112 may comprise any number of routers 114 and links 116 in a ring network. The methods and systems disclosed herein apply not just to on-chip networks, but the methods and systems are especially applicable to on-chip networks as on-chip networks typically may have tight constraints on performance and complexity.

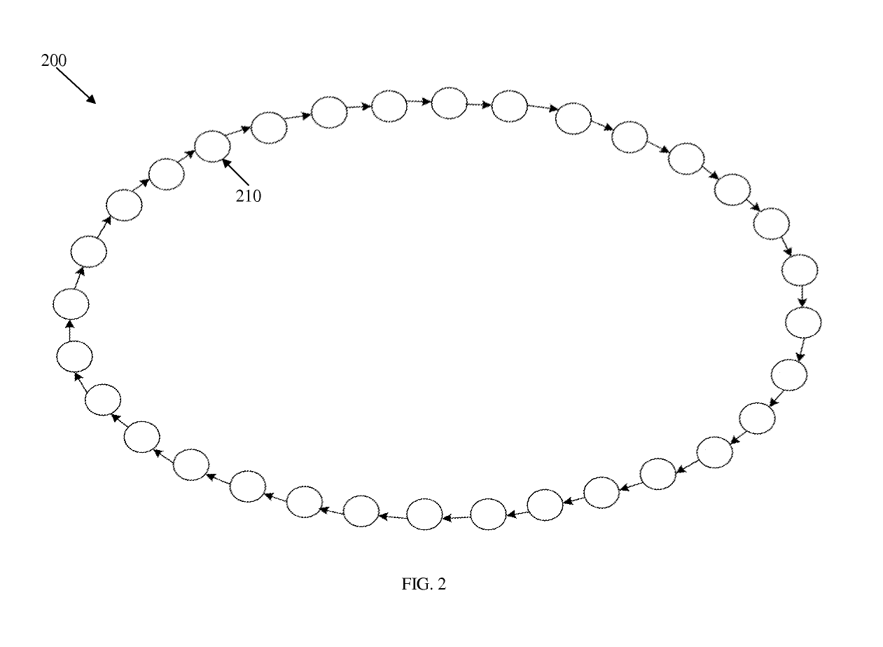

FIG. 2 shows a schematic diagram of a ring network 200 with thirty-two routers, which may be part of an on-chip network. The ring network comprises a plurality of routers, a representative one of which is labeled as 210. Router 210 has one input port and one output port, corresponding to one input link and one output link, respectively, as shown in FIG. 2. The remaining thirty-one routers are of similar structure. If ring network 200 is implemented in an on-chip network, each of a plurality of routers may paired with a component on a chip, such as a memory or a processor, in which case there may be at least one additional input port and one additional output port for communicating with the corresponding component. Although illustrated with thirty-two routers, a ring network may contain any number of routers.

In a thirty-two router unidirectional ring network, the maximum latency is thirty-one router hops. That is, a flit must travel over a maximum of thirty-one links to reach its destination. Some flits will be injected into the ring network 200 close to their destination router, e.g., requiring one hop only, while other flits will be injected into ring network 200 relatively far away from their destination router, e.g., thirty-one hops away. Generally, the average latency in a thirty-two router unidirectional ring network is approximately fifteen router hops.

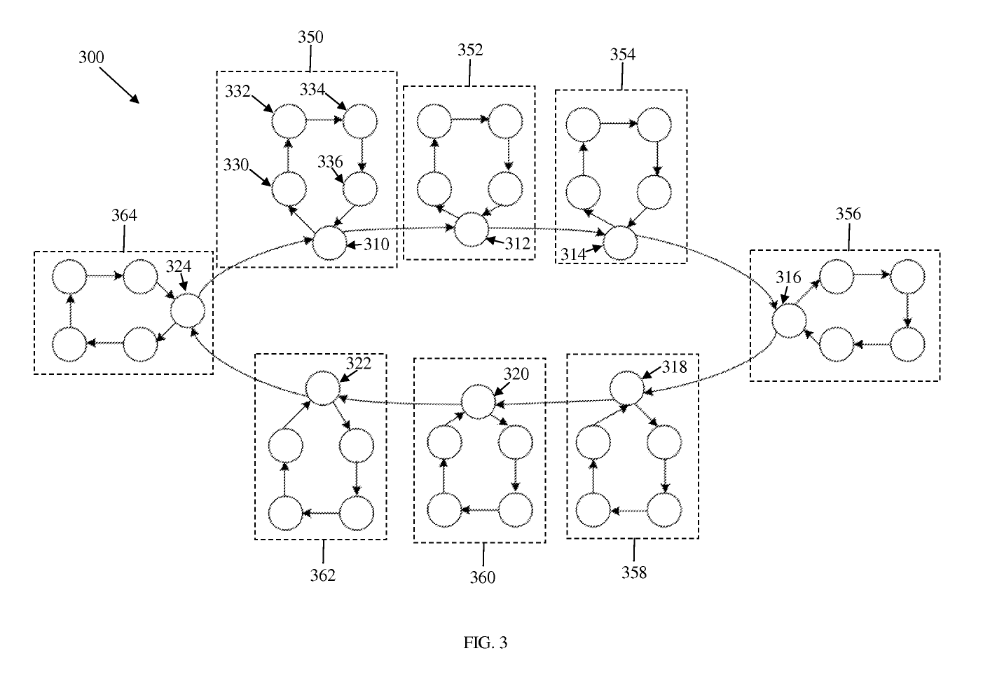

It is desirable to significantly reduce latency of ring network 200 without significantly increasing complexity. One topology that may achieve these goals is presented in FIG. 3, which is a schematic diagram of a hierarchical ring network 300. Hierarchical ring network 300 comprises local routers and global routers. Each of the circles in FIG. 3 denotes a router, which may be either a local router or a global router, but not both. An on-chip network may comprise hierarchical ring network 300.

Local routers may be routers with similar structure and functionality to routers used in conventional ring networks, such as ring network 200 in FIG. 2. A local router may comprise only one input port and only one output port with respect to the local ring. Also, local routers have only one input port and one output port with respect to an off-ring component. For example, if hierarchical ring 300 is implemented as part of an on-chip network, each of the local routers may be coupled to a component on a chip, such as a memory or a processor, in which case there may be only one input port and one output port for communicating with the corresponding off-ring component. A local router may receive flits from another local router, a global router, or an off-ring component via its input ports and may transmit flits to another local router, a global router, or an off-ring component via its output ports. Examples of local routers are presented in FIG. 3 as routers 330, 332, 334, and 336. Overall, there are thirty-two local routers in FIG. 3.

A global router may be a router comprising two input ports and two output ports. Specifically, a global router may have only one input port for receiving flits from another global router, one input port for receiving flits from a local router, one output port for transmitting flits to another global router, and one output port for transmitting flits to a local router. There may be no input ports or output ports for connecting to off-ring components, as global routers may not be coupled to off-ring components, such as memories or processors on a chip. Examples of global routers are presented in FIG. 3 as routers 310, 312, 314, 316, 318, 320, 322, and 324. The global routers may be interconnected in a global ring as illustrated in FIG. 3. That is, the global ring includes all global routers—global routers 310, 312, 314, 316, 318, 320, 322, and 324. Global routers may be distinguished from local routers and intermediate routers (discussed below) in that the global ring to which they belong is the inner-most ring in the network (e.g., there are no higher rings in the hierarchical ring topology.) Each global router may be interconnected between two other global routers. For example, global router 312 is between global routers 310 and 314. Global routers may be employed to route traffic between clusters of local routers, wherein a cluster may comprise a plurality of local routers. A global router together with its corresponding cluster of local routers may form a ring, referred to as a local ring. Examples of such local rings are indicated as 350, 352, 354, 356, 358, 360, 362, and 364. A hierarchical ring network generally may comprise a global ring network and a plurality of local ring networks extending off of the global ring network.

As compared to the ring network 200 in FIG. 2, the hierarchical ring network 300 in FIG. 3 comprises thirty-two local routers, which are equal in number and similar in structure to the thirty-two routers in ring network 200. However, the hierarchical ring network 300 adds eight global routers as compared to the ring network 200. In exchange for a moderate increase in complexity introduced by the global routers and the hierarchical topology, latency may be reduced significantly in hierarchical ring network 300 as compared to ring network 200. Maximum latency may be reduced by approximately 52% from thirty-one hops in ring network 200 to just fifteen hops in hierarchical ring network 300. Moreover, average latency may be reduced by approximately 40% from roughly fifteen hops to roughly nine hops.

Although FIG. 3 shows the thirty-two routers divided into eight clusters of four local routers each, any number of clusters with any number and/or configuration of local and global routers may be possible and within the scope of this application. For example, the thirty-two local routers may be divided instead into four clusters of eight local routers each. In such a case, only four global routers may be needed. Note that in exchange for this reduction in complexity from eight global routers, maximum and average latency may be increased compared with the hierarchical ring 300.

Moreover, a hierarchical ring may comprise any number of local routers. For example, a hierarchical ring may comprise 128 local routers. And these routers may, for example, be divided into eight clusters of sixteen local routers each, in which case eight global routers may be used to interconnect the clusters. It is also not necessary for each cluster to contain the same number of local routers. In the example of 128 local routers above, there may, for example, be two clusters with eight local routers each and seven clusters with sixteen local routers each.

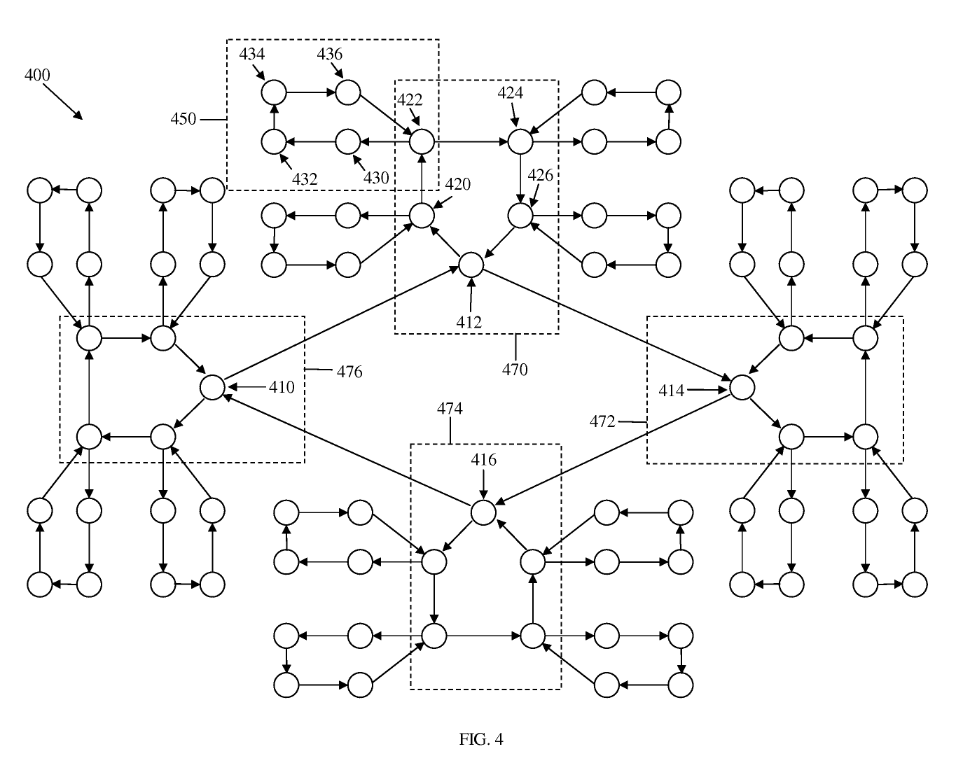

The hierarchical ring 300 presented in FIG. 3 may be considered to be a two-level hierarchical ring, with a first level comprising a global ring and a second level comprising a plurality of local rings. These concepts can be extended to any number of levels, and an example of a hierarchical ring 400 with three levels of rings is shown in FIG. 4. The hierarchical ring 400 comprises a global ring, which may be considered to be a first level ring, comprising global routers 410, 412, 414, and 416. This global ring interconnects four intermediate rings 470, 472, 474, and 476, each of which comprises four intermediate routers, in addition to one global router. For example, intermediate ring 470 comprises intermediate routers 420, 422, 424, and 426 and global router 412. Each of the four intermediate rings 470, 472, 474, and 476 may be considered to be a second level of rings. There are sixteen local rings, which may be considered to be a third level of rings. Each of the intermediate rings interconnects four local rings in hierarchical ring 400. An example local ring is indicated as 450 in FIG. 4. Local ring 450 comprises four local routers 430, 432, 434, and 436 and one intermediate router 422 interconnected in a local ring. There are sixty-four local routers, sixteen intermediate routers, and four global routers in hierarchical ring 400 in FIG. 4. The maximum and average latencies of hierarchical ring 400 may be reduced compared with a conventional ring network with sixty-four routers at the expense of twenty additional routers (sixteen intermediate routers and four global routers). An on-chip network may comprise hierarchical ring 400.

Generally, intermediate rings may be introduced into a hierarchical ring to extend a hierarchical ring beyond two levels of rings to three or more levels of rings. Intermediate rings comprise intermediate routers, and an intermediate router may be a router comprising two input ports and two output ports. Specifically, an intermediate router may have only one input port for receiving flits from an adjacent intermediate router, one input port for receiving flits from an adjacent local router, one output port for transmitting flits to an adjacent intermediate router or an adjacent global router as the case may be, and one output port for transmitting flits to an adjacent local router. There may be no input ports or output ports for connecting to off-ring components, as intermediate routers may not be coupled to off-ring components, such as memories or processors on a chip. Examples of intermediate routers are presented in FIG. 4 as routers 420, 422, 424, and 426. The intermediate routers may be interconnected in intermediate rings as illustrated in FIG. 4.

Hierarchical ring 400 is but one of many possible configurations of hierarchical rings that include sixty-four local routers. Each of the configurations is within the scope of this application, and configurations with different numbers and/or configurations of local, intermediate, and global routers are also within the scope of this application.

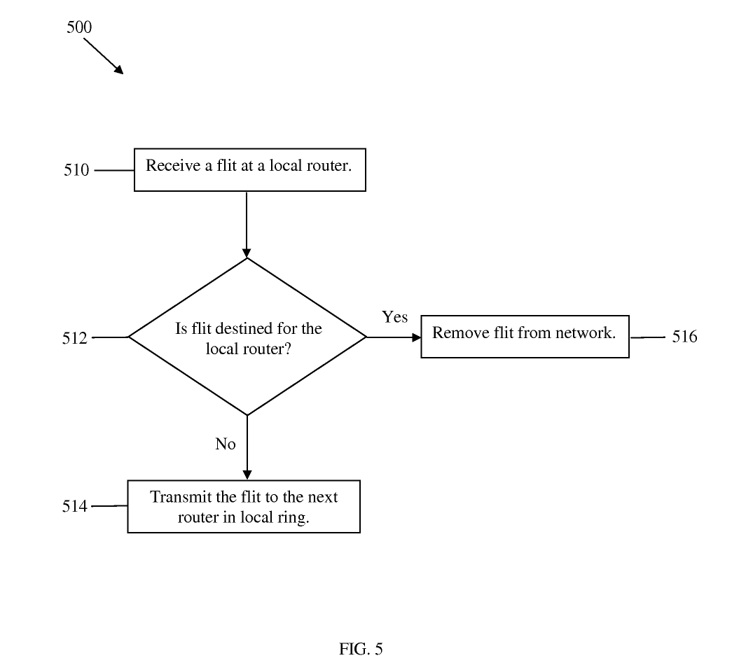

Hierarchical rings may require new methods of routing because routers may be interconnected with more than one ring. For example, global router 412 in FIG. 4 is part of two rings—a global ring comprising global routers 410, 412, 414, and 416 and an intermediate ring comprising intermediate routers 420, 422, 424, and 426 and global router 412. FIGS. 5, 6, and 7 are embodiments of flit routing methods for local, intermediate, and global routers, respectively. Local and global routers may exist in hierarchical networks with two or more levels of rings, and intermediate routers may exist in hierarchical networks with three or more levels of rings. The steps of FIGS. 5, 6, and 7 may be implemented in local, intermediate, and global routers, respectively, in a hierarchical ring network such as hierarchical ring network 400 in FIG. 4.

FIG. 5 is a flowchart of an embodiment of flit routing method 500 for a local router. In step 510, a flit is received at a local router, which may necessarily reside in a local ring network. The flit may be received from another local router or an off-ring component in an on-chip network. Next at decision block 512, a determination is made whether the flit is destined for the local router as its final destination in the hierarchical network. If so, the method proceeds to step 516, in which the flit is removed from the network. The flit may be removed from the network in an on-chip network by extracting information from the flit and transmitting the information to an off-ring component in an on-chip network. If the flit is not destined for the local router, the method proceeds to step 514, in which the flit is transmitted to the next router in the local ring network. The next router may be a global router, an intermediate router, or another local router, depending on the configuration of the hierarchical network and the position of the local router in the network.

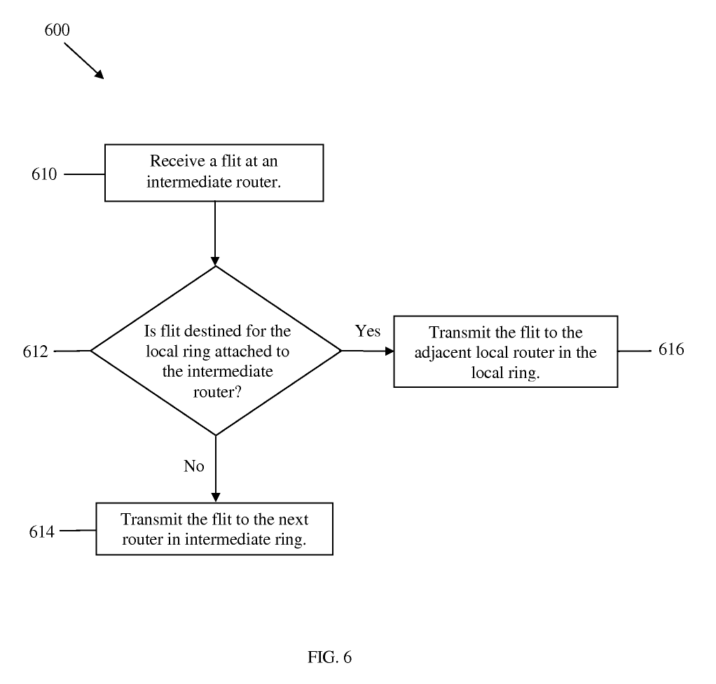

FIG. 6 is a flowchart of an embodiment of flit routing method 600 for an intermediate router, which may necessarily reside in an intermediate ring network. In step 610, a flit is received at an intermediate router. The flit may be received from another intermediate router, a global router, or a local router, depending on the configuration. Next at decision block 612, a determination is made whether the flit is destined for the local ring attached to the intermediate router. If so, the method proceeds to step 616, in which the flit is transmitted to the adjacent local router in the local ring. If the flit is not destined for the local ring attached to the intermediate router, the method proceeds to step 614, in which the flit is transmitted to the next router in the intermediate ring network. The next router may be a global router, another intermediate router, or a local router, depending on the configuration of the hierarchical network and the position of the intermediate router in the network.

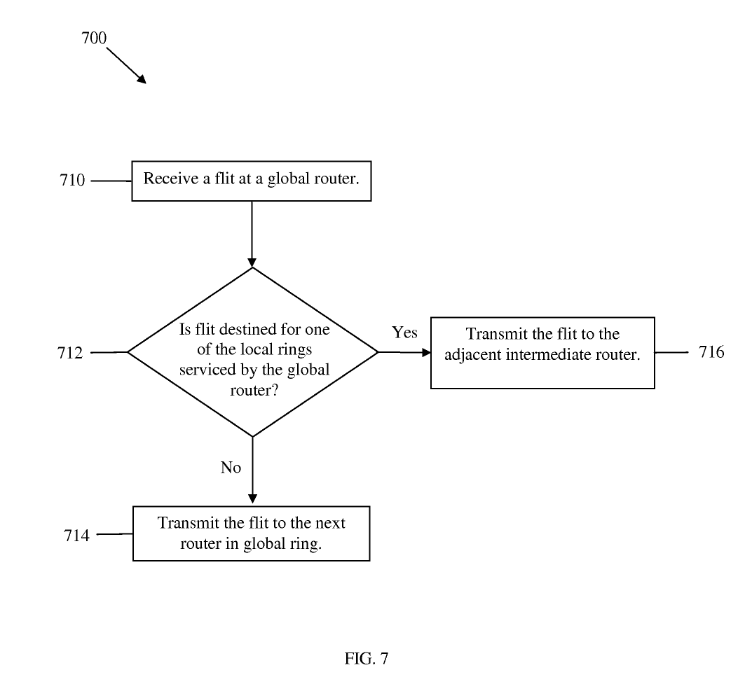

FIG. 7 is a flowchart of an embodiment of flit routing method 700 for a global router. In step 710, a flit is received at a global router. The flit may be received from another global router, an intermediate router, or a local router depending on the configuration of the hierarchical network and the position of the global router in the network. Next at decision block 712, a determination is made whether the flit is destined for one of the local rings serviced by the global router. Using the hierarchical ring 400 in FIG. 4 as an example, global router 412 would decide whether a flit is destined for any of four local rings, including local ring 450, serviced by the global router 412. If so, the method proceeds to step 716, in which the flit is transmitted to the adjacent intermediate router. If the flit is not destined for one of the local rings serviced by the global router, the method proceeds to step 714, in which the flit is transmitted to the next router in the global ring network. Returning to FIG. 4 as an example, global router 412 would transmit the flit global router 414.

The steps of FIGS. 5, 6, and 7 may be used to route a flit from source to destination in a hierarchical ring network, such as the hierarchical ring network 400 in FIG. 4. A flit may enter and exit a network using the steps in FIG. 5, and a flit may navigate the network using the steps in FIGS. 5, 6, and 7. There may be no intermediate nodes in a two-level network, such as hierarchical ring network 300 in FIG. 3, in which case the steps in FIG. 6 for intermediate routers may not be performed, and the steps in FIGS. 5 and 7 would be modified slightly to account for the fact that global routers may connect directly to local routers, not intermediate routers, as well as to other global routers.

The embodiments of hierarchical ring networks disclosed herein are examples that utilize unidirectional links. For example, the embodiments of hierarchical networks 300 and 400 in FIGS. 3 and 4, respectively, utilize only unidirectional links. One reason why the use of unidirectional links may be beneficial may be to satisfy complexity constraints on routers. Nonetheless, hierarchical rings may instead employ bidirectional links at the expense of some added complexity. As clock speeds continue to increase and transistor sizes continue to decrease, the added complexity may not be a barrier to implementation.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a chip comprising:
a global ring network comprising a plurality of global routers configured in a unidirectional ring network; and
a plurality of local ring networks directly connected to the global ring network.

2. The apparatus of claim 1, wherein each of the local ring networks comprises a unidirectional ring network comprising a plurality of local routers and a global router from the plurality of global routers.

3. The apparatus of claim 2, wherein each global router from the plurality of global routers is paired with only one local ring network in a one-to-one correspondence, and wherein none of the local ring networks are directly connected to each other.

4. The apparatus of claim 3, wherein each of the local routers in the local ring networks comprises only one input port and only one output port for its local ring network, and wherein each of the plurality of global routers comprises only one input port and only one output port for the global ring network, and wherein each of the global routers comprises only one input port and only one output port for its paired local ring network.

5. The apparatus of claim 4, wherein each of the plurality of global routers is configured to receive a flit, determine whether the flit is destined for the global ring network or one of the local ring networks, and choose a route for the flit based on the determination.

6. The apparatus of claim 5, wherein the chip further comprises a memory and a processor, wherein a first local router in one of the local ring networks is configured to receive data from the memory, and wherein a second local router in one of the local ring networks is configured to receive data from the processor.

7. A method comprising:
transmitting a first flit from a first router to a second router, wherein a first ring network comprises the first and second routers; and
transmitting a second flit from the first router to a third router, wherein a second ring network comprises the first and third routers,
wherein the first and second ring networks are in a hierarchical relationship with each other, and
wherein a chip comprises the first and second ring networks.

8. The method of claim 7, wherein the first router is directly connected to the second router, and wherein the first router is directly connected to the third router.

9. The method of claim 8, wherein transmitting the first flit is in response to a determination that the first flit is not destined for the second ring network.

10. The method of claim 9, wherein the first router is a global router, wherein the second router is a global router, and wherein the third router is a local router.

11. The method of claim 10, further comprising receiving the first flit from a fourth router in the first ring network, wherein the first ring network is a first global ring network and the second ring network is a local ring network.

12. The method of claim 11, wherein the fourth router is directly connected to a second global ring network.

13. The method of claim 12, wherein the chip further comprises a memory and a processor, and wherein the method further comprises:
receiving data from the memory by the third router; and
receiving data from the processor by a local router in the second ring network.

14. An apparatus comprising:
a chip comprising:
a global ring network comprising a plurality of global routers configured in a unidirectional ring network;
an intermediate ring network comprising a plurality of intermediate routers configured in a unidirectional ring network, wherein the intermediate ring network is directly connected to the global ring network; and
a plurality of local ring networks directly connected to the intermediate ring network.

15. The apparatus of claim 14, wherein each of the local ring networks comprises a unidirectional ring network comprising a plurality of local routers and only one of the intermediate routers, and wherein the global ring network, the intermediate ring network, and the local ring network are in a hierarchical relationship with each other.

16. The apparatus of claim 15, wherein each of the local routers comprises only one input port and only one output port for its local ring network, wherein one of the global routers comprises only one input port and only one output port for the global ring network, and wherein the one of the global routers comprises only one input port and only one output port for the intermediate ring network.

17. The apparatus of claim 16, wherein each intermediate router is paired with only one local ring network in a one-to-one correspondence, and wherein none of the local ring networks are directly connected to each other.

18. The apparatus of claim 17, wherein each of the intermediate routers comprises only one input port and only one output port for the intermediate ring network, and wherein each of the intermediate routers comprises only one input port and one output port for its corresponding local ring.

19. The apparatus of claim 18, wherein each of the intermediate routers is configured to receive a flit, determine whether the flit is destined for one of the local ring networks or the intermediate ring network, and choose a route for the flit based on the determination.

20. The apparatus of claim 19, wherein the chip further comprises a memory and a processor, wherein a first local router in one of the local ring networks is configured to receive data from the memory, and wherein a second local router in one of the local ring networks is configured to receive data from the processor.
